(19) United States
(12) Patent Application Publication
(10) Pub. No.: US 2018/0057170 A1
(43) Pub. Date: Mar. 1, 2018

(54) ENHANCED METHOD AND AIRCRAFT FOR PRE-COOLING AN ENVIRONMENTAL CONTROL SYSTEM USING A TWO WHEEL TURBO-MACHINE WITH SUPPLEMENTAL HEAT EXCHANGER

(71) Applicant: GE AVIATION SYSTEMS, LLC, Grand Rapids, MI (US)

(72) Inventor: Dominique Patrick Sautron, Chicago, IL (US)

(21) Appl. No.: 15/244,086

(22) Filed: Aug. 23, 2016

(51) Int. Cl. B64D 13/06

(52) U.S. Cl. CPC B64D 13/06; B64D 2013/0648; B64D 2013/0618

(57) ABSTRACT

A method and aircraft for providing bleed air to environmental control systems of an aircraft using a gas turbine engine, including determining a bleed air demand for the environmental control systems, selectively supplying low pressure and high pressure bleed air to the environmental control systems, wherein the selectively supplying is controlled such that the conditioned air stream satisfies the determined bleed air demand.

### BACKGROUND OF THE INVENTION

Contemporary aircraft have bleed air systems that take hot air from the engines of the aircraft for use in other systems on the aircraft including environmental control systems (ECS) such as air-conditioning, pressurization, and de-icing. The ECS can include limits on the pressure or temperature of the bleed air received from the bleed air systems. Currently, aircraft engine bleed systems make use of a pre-cooler heat exchanger to pre-condition the hot air from the engines to sustainable temperatures, as required or utilized by the other aircraft systems. The pre-cooler heat exchangers produce waste heat, which is typically exhausted from the aircraft without utilization.

### BRIEF DESCRIPTION OF THE INVENTION

In one aspect of the present disclosure, a method of providing bleed air to the environmental control system using a gas turbine engine includes determining a bleed air demand for the environmental control system, selectively supplying low pressure bleed air and high pressure bleed air from a compressor of the gas turbine engine to a turbine section and compressor section of a turbo air cycle machine, with the turbine section emitting a cooled air stream and the compressor section emitting a compressed air stream, selectively cooling the compressed air stream; and combining the cooled air stream emitted from the turbine section and the compressed air stream emitted from the compressor section to form a conditioned air stream wherein the selectively supplying and selectively cooling are controlled such that the conditioned air stream satisfies the determined bleed air demand.

In another aspect of the present disclosure, an aircraft includes an environmental control system having a bleed air inlet, a gas turbine engine having a low pressure bleed air supply and a high pressure bleed air supply, a turbo air cycle machine having rotationally coupled turbine section and compressor section, an upstream turbo-ejector fluidly coupling the low and high pressure bleed air supplies to the turbine section and compressor section, a downstream turbo-ejector fluidly combining fluid outputs from the turbine section and compressor section into a common flow that is supplied to the bleed air inlet of the environmental control system, and a heat exchanger having a hot side fluidly coupled between the compressor section and the downstream turbo-ejector.

In yet another aspect of the present disclosure, a method of providing air to an environmental control system of an aircraft includes selectively supplying ambient air or low pressure bleed air and high pressure bleed air from a compressor of a gas turbine engine to a turbo air cycle machine to precondition the ambient air and bleed air according to operational demands of the environmental control system.

### BRIEF DESCRIPTION OF THE DRAWINGS

In the drawings:

FIG. 1 is a perspective view of an aircraft having a bleed air system in accordance with various aspects described herein.

FIG. 2 is a schematic cross-sectional view of a portion of an exemplary aircraft gas turbine engine that can be utilized in the aircraft of FIG. 1.

FIG. 3 is a schematic view of a gas turbine engine bleed air system that can be utilized in the aircraft of FIG. 1 in accordance with various aspects described herein.

FIG. 4 is a schematic view of a gas turbine engine bleed air system that can be utilized in the aircraft of FIG. 1 in accordance with various aspects described herein.

FIG. 5 is an example a flow chart diagram illustrating a method of providing bleed air to the environmental control system in accordance with various aspects described herein.

### DESCRIPTION OF EMBODIMENTS OF THE INVENTION

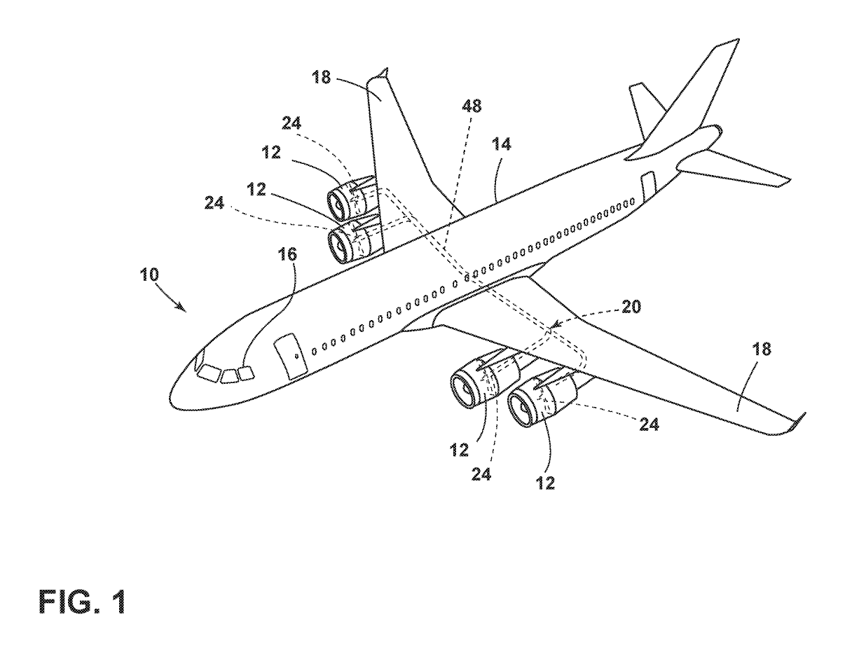

FIG. 1 illustrates an embodiment of the disclosure, showing an aircraft 10 that can include a bleed air system 20, only a portion of which has been illustrated for clarity purposes. As illustrated, the aircraft 10 can include multiple engines, such as gas turbine engines 12, a fuselage 14, a cockpit 16 positioned in the fuselage 14, and wing assemblies 18 extending outward from the fuselage 14. The aircraft can also include an environmental control system (ECS) 48. The ECS 48 is schematically illustrated in a portion of the fuselage 14 of the aircraft 10 for illustrative purposes only. The ECS 48 is fluidly coupled with the bleed air system 20 to receive a supply of bleed air from the gas turbine engines 12.

The bleed air system 20 can be connected to the gas turbine engines 12 such that high temperature, high pressure air, low temperature, low pressure air, or a combination thereof received from the gas turbine engines 12 can be used within the aircraft 10 for environmental control of the aircraft 10. More specifically, an engine can include a set of bleed ports 24 arranged along the gas turbine engine 12 length or operational stages such that bleed air can be received, captured, or removed from the gas turbine engine 12 as the corresponding set of bleed ports 24. In this sense, various bleed air characteristics, including but not limited to, bleed air mass flow rate (for example, in pounds per minute), bleed air temperature or bleed air pressure, can be selected based on the desired operation or bleed air demand of the bleed air system 20. Further, it is contemplated that ambient air can be used within the aircraft 10 for environmental control of the aircraft 10. As used herein, the environmental control of the aircraft 10, that is, the ECS 48 of the aircraft 10, can include subsystems for anti-icing or de-icing a portion of the aircraft, for pressurizing the cabin or fuselage, heating or cooling the cabin or fuselage, and the like. The operation of the ECS 48 can be a function of at least one of the number of aircraft 10 passengers, aircraft 10 flight phase, or operational subsystems of the ECS 48. Examples of the aircraft 10 flight phase can include, but is not limited to ground idle, taxi, takeoff, climb, cruise, descent, hold, and landing. The demand of the bleed air system 20 by the ECS can be dynamic as, for example, subsystems are needed based on aircraft 10 conditions.

While a commercial aircraft 10 has been illustrated, it is contemplated that embodiments of the invention can be used in any type of aircraft 10. Further, while two gas turbine engines 12 have been illustrated on the wing assemblies 18, it will be understood that any number of gas turbine engines 12 including a single gas turbine engine 12 on the wing assemblies 18, or even a single gas turbine engine mounted in the fuselage 14 can be included.

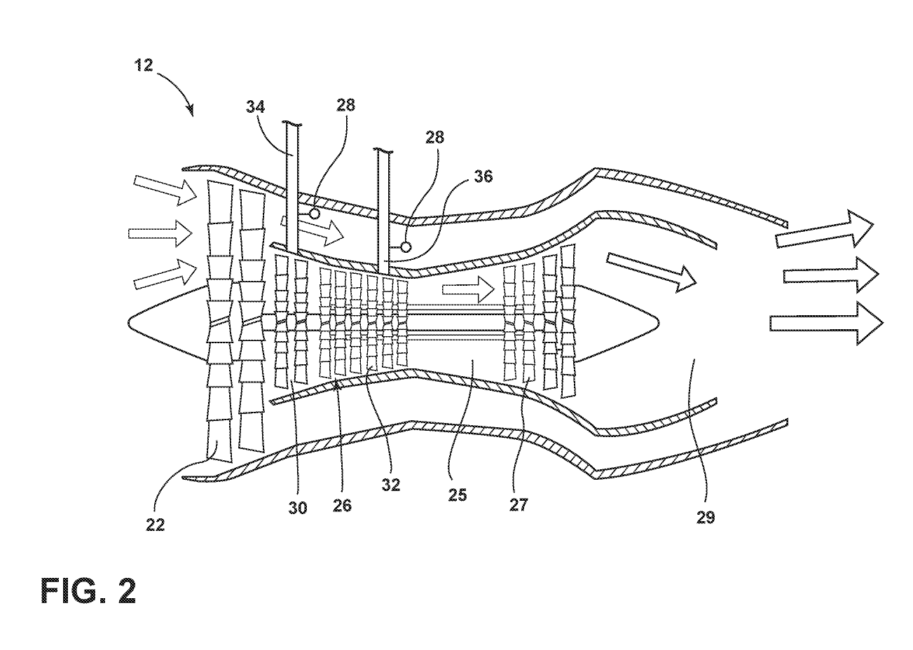

FIG. 2 illustrates a cross section of the gas turbine engine 12 of the aircraft 10. The gas turbine engine 12 can include, in a serial relationship, a fan 22, a compressor section 26, a combustion section 25, a turbine section 27, and an exhaust section 29. The compressor section 26 can include, in a serial relationship, a multi-stage low pressure compressor 30 and a multi-stage high pressure compressor 32.

The gas turbine engine 12 is also shown including a low pressure bleed port 34 arranged to pull, draw, or receive low pressure bleed air from the low pressure compressor 30 and a high pressure bleed port 36 arranged to pull, draw, or receive high pressure bleed air from the high pressure compressor 32. The bleed ports 34, 36 are also illustrated coupled with various sensors 28, which can provide corresponding output signals. By way of non-limiting example, the sensors 28 can include respective temperature sensors, respective flow rate sensors, or respective pressure sensors. While only a single low pressure bleed port 34 is illustrated, the low pressure compressor 30 can include a set of low pressure bleed ports 34 arranged at multiple stages of the compressor 30 to pull, draw, or receive various bleed air characteristics, including but not limited to, bleed air mass flow rate, bleed air temperature, or bleed air pressure. Similarly, while only a single high pressure bleed port 36 is illustrated, the high pressure compressor 32 can include a set of high pressure bleed ports 36 to pull, draw, or receive various bleed air characteristics, including but not limited to, bleed air mass flow rate, bleed air temperature, or bleed air pressure. Non-limiting embodiments of the disclosure can further include configurations wherein at least one of the low or high pressure bleed port 34, 36 can include a bleed port from an auxiliary power units (APU) or ground cart units (GCU) such that the APU or GCU can provide an augmented pressure and conditioned temperature airflow in addition to or in place of the engine bleed ports 34, 36.

During gas turbine engine 12 operation, the rotation of the fan 22 draws in air, such that at least a portion of the air is supplied to the compressor section 26. The air is pressurized to a low pressure by the low pressure compressor 30, and then is further pressurized to a high pressure by the high pressure compressor 32. At this point in the engine operation, the low pressure bleed port 34 and the high pressure bleed port 36 draw, respectively low pressure air from the low pressure compressor 30 and high pressure air from the high pressure compressor 32 and supply the air to a bleed air system for supplying air to the ECS 48. High pressure air not drawn by the high pressure bleed port 36 is delivered to the combustion section 25, wherein the high pressure air is mixed with fuel and combusted. The combusted gases are delivered downstream to the turbine section 27, which are rotated by the gases passing through the turbine section 27. The rotation of the turbine section 27, in turn, rotates the fan 22 and the compressor section 26 upstream of the turbine section 27. Finally, the combusted gases are exhausted from the gas turbine engine 12 through the exhaust section 29.

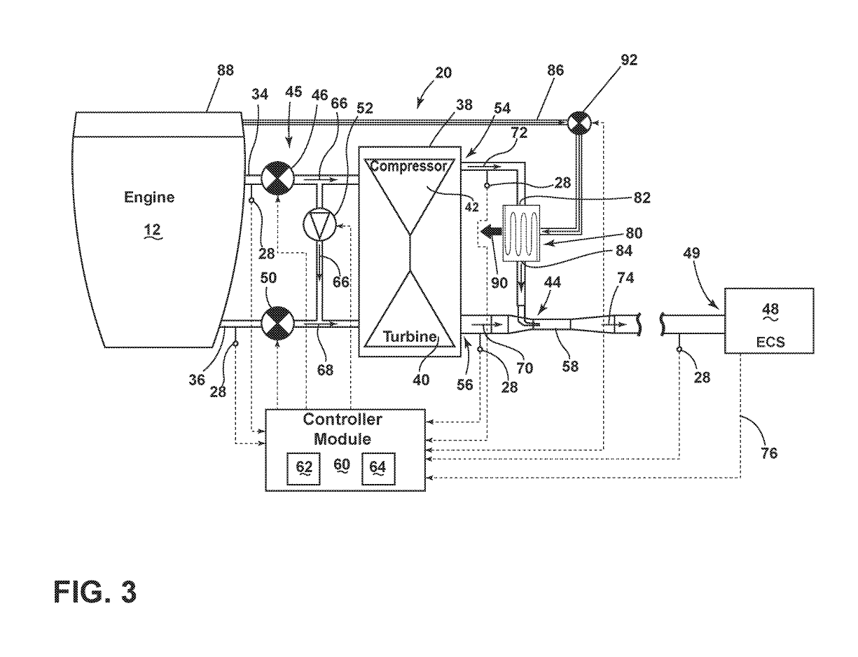

FIG. 3 illustrates a schematic view of portions of the aircraft 10 including the gas turbine engine 12, the bleed air system 20, and the ECS 48. As shown, the bleed air system 20 can include a turbo air cycle machine 38 fluidly coupled upstream with the set of gas turbine engine (shown only as a single gas turbine engine 12) and fluidly coupled downstream with the ECS 48. The turbo air cycle machine 38 can include a turbine section 40 and a compressor section 42, such as a turbo compressor, rotatably coupled on a common shaft with the turbine section 40. The bleed air system 20 of the turbo air cycle machine 38 can include a flow mixer or turbo-ejector 44 located downstream from the turbo air cycle machine 38.

The low pressure and high pressure bleed ports 34, 36 can be fluidly coupled with the turbo air cycle machine 38 by way of a proportional mixing or controllable valve assembly 45. Non-limiting examples of the controllable valve assembly 45 can include mixing, proportional mixing, or non-mixing configurations. In another non-limiting example, the proportional mixing assembly can include a proportional mixing-ejector valve assembly. In one aspect, the proportional mixing-ejector valve assembly or controllable valve assembly 45 can be arranged to supply the low pressure and high pressure bleed air to the turbo air cycle machine 38. Non-limiting examples of the proportional mixing-ejector valve assembly or controllable valve assembly 45 can include a turbo-ejector or mixing-ejector assembly, wherein the high pressure bleed port 36 entrains at least a portion of the low pressure bleed air of the low pressure bleed port 34, or “pulls” air from the low pressure bleed port 34, and provides the mixed, combined, or entrained air to the turbo air cycle machine 38. Stated another way, the proportional turbo-ejector or mixing-ejector assembly can simultaneously supply at least a portion of the low pressure bleed air to the compressor section 42 and entrain another portion of the low pressure bleed air with the high pressure bleed air.

Embodiments of the disclosure can include aspects wherein the supply ratio of the low pressure bleed air and high pressure bleed air can be selected to never go below, or alternatively, to never exceed, a predetermined ratio. In one example, the aspects of the supply ratio can include, or can be determined to maintain an energy or power balance between the turbine section 40 and compressor section 42 of the turbo air cycle machine 38. Another non-limiting example of the proportional mixing-ejector valve assembly or controllable valve assembly 45 can be included wherein the low pressure bleed port 34 of the gas turbine engine 12 can be fluidly coupled with the compressor section 42 of the turbo air cycle machine 38 by way of a first controllable valve 46. Additionally, the high pressure bleed port 36 of the gas turbine engine 12 can be directly fluidly coupled with the turbine section 40 of the turbo air cycle machine 38 by way of a second controllable valve 50. Non-limiting examples of the first or second controllable valves 46, 50 can include a fully proportional or continuous valve.

The proportional valve can operate in response to, related to, or as a function of the aircraft flight phase or the rotational speed of the gas turbine engine 12. For example, the rotational speed of the gas turbine engine 12 can vary within an operating cycle, during which the proportional mixing-ejector valve assembly or controllable valve assembly 45 can be adjusted based on gas turbine engine transient or dynamic conditions. Embodiments of the disclosure can supply any ratio of low pressure bleed air to high pressure bleed air, such as 100% of first bleed air, and 0% of second bleed air. Similarly, the ratio can be predetermined based on dynamic response to engine conditions and to maintain energy balance or power balance between the turbine and compressor sections of the turbo air cycle machine assembly.

The low pressure bleed air provided by the low pressure bleed port 34 can be further provided to the turbine section 40, downstream of the respective first and second controllable valves 46, 50, wherein a fluid coupling providing the low pressure bleed air to the turbine section 40 can include a check valve 52 biased in the direction from the low pressure bleed port 34 toward the high pressure bleed port 36 or the turbine section 40 of the turbo air cycle machine 38. In this sense, the check valve 52 is configured such that fluid can only flow from the low pressure bleed port 34 to the high pressure bleed port 36 or the turbine section 40 of the turbo air cycle machine 38.

Embodiments of the disclosure can be included wherein the check valve 52 is selected or configured to provide fluid traversal from the low pressure bleed port 34 toward the high pressure bleed port 36 under defined or respective pressures of the flow in the respective the low pressure bleed port 34 toward the high pressure bleed port 36. For example, the check valve 52 can be selected or configured to only provide fluid traversal, as shown, the air pressure of the high pressure bleed port 36 is lower or less than the air pressure of the low pressure bleed port 34. In another example, the check valve 52 can be selected or configured such that the valve 52 closes, or self-actuates to a closed position under back pressure, that is when the pressure of the high pressure bleed port 36 is higher or greater than the air pressure of the low pressure bleed port 36. Alternatively, embodiments of the disclosure can include a check valve 52 or the proportional turbo-ejector or the mixing-ejector assembly that is controllable to provide selective fluid traversal from the low pressure bleed port 34 toward the high pressure bleed port 36.

The compressor section 42 of the turbo air cycle machine 38 can include a compressor output 54, and the turbine section 40 can include a turbine output 56. In the illustrated example, a heat exchanger 80 is fluidly coupled between the compressor output 54 and the turbo-ejector 44. It will be understood that the heat exchanger 80 can be any suitable heat exchanger utilizing any suitable cooling fluid. Compressor output airflow 72 can be fed to a hot side of the heat exchanger 80. More specifically the compressor output airflow 72 can be introduced to an inlet 82 of the heat exchanger 80, can flow through the hot side of the heat exchanger 80 and can be emitted through an outlet 84 of the heat exchanger 80.

By way of non-limiting example, a cool air conduit 86 has been illustrated as being selectively fluidly coupled to the cool side of the heat exchanger 80, through a fan air valve 92. The cool air conduit 86 in the illustrated example can utilize air from within the fan casing 88 of the gas turbine engine 12 and supply such air to the heat exchanger 80. Once the air has passed through the heat exchanger 80 it can be expelled through an exhaust 90, shown schematically as an arrow. It will be understood that any suitable exhaust system can be utilized including that the air can exhaust to ambient. The flow of air through the heat exchanger 80 can be controlled by the fan air valve 92. It will be understood that the fan air valve 92 include a proportional or continuous valve. The proportional valve can operate in response to, related to, or as a function of a desired temperature for the compressor output airflow 72, or as a function of a desired temperature for the turbo-ejector output airflow.

Regardless of whether cooling air is introduced into the heat exchanger 80 by the fan air valve 92, the compressor output 54 flows through the heat exchanger 80. The compressor output 54 and the turbine output 56 are then fluidly combined downstream of the turbo air cycle machine 38. The flow mixer is arranged to fluidly combine the compressor output 54 and the turbine output 56 to a common mixed flow that is supplied to the bleed air inlet 49 of the ECS 48. In this sense, the bleed air system 20 preconditions the bleed air before the bleed air is received by the bleed air inlet 49 of the ECS 48.

In the illustrated embodiment of the flow mixer, the turbo-ejector 44 pressurizes the turbine output 56 as it traverses a narrow portion 58, or “throat” of the turbo-ejector 44, and fluidly injects the compressor output 54 into the narrow portion 58 of the turbo-ejector 44. The injection of the compressor output 54 into the pressurized turbine output 56 at the narrow portion 58 of the turbo-ejector 44 fluidly combines the respective outputs 54, 56. The turbo-ejector 44 or combined outputs 54, 56 are fluidly coupled downstream with the ECS 48 at a bleed air inlet 49. Embodiments of the disclosure can be included wherein the compressor output 54, the turbine output 56, or the turbo-ejector 44 (e.g. downstream from the narrow portion 58) can include a set of sensors 28.

The turbo-ejector 44, sometimes referred to as an “ejector pump” or an “ejector valve,” works by injecting air from a higher pressure source into a nozzle at the input end of a venturi restriction, into which a lower pressure air source is also fed. Air from the higher pressure source is emitted downstream into the lower pressure flow at high velocity. Friction caused by the adjacency of the airstreams causes the lower pressure air to be accelerated (“entrained”) and drawn through the venturi restriction. As the higher pressure air ejected into the lower pressure airstream expands toward the lower pressure of the low pressure air source, the velocity increases, further accelerating the flow of the combined or mixed airflow. As the lower pressure air flow is accelerated by its entrainment by the higher pressure source, the temperature and pressure of the low pressure source are reduced, resulting in more energy to be extracted or “recovered” from the turbine output. Non-limiting embodiments of the disclosure can be included wherein the high pressure air source is at a higher or greater temperature than the low pressure air source. However, in alternative embodiments of the disclosure, the entrainment and mixing process can occur without the high pressure air source having a higher or greater temperature than the low pressure air source. The above-described embodiments are application to the turbo-ejector 44 illustrated downstream of the turbo air cycle machine 38, as well as to the turbo-ejector embodiment of the controllable valve assembly 45.

The aircraft 10 or bleed air system 20 can also include a controller module 60 having a processor 62 and memory 64. The controller module 60 or processor 62 can be operably or communicatively coupled to the bleed air system 20, including its sensors 28, the first controllable valve 46, the second controllable valve 50, the fan air valve 92, and the ECS 48. The controller module 60 or processor 62 can further be operably or communicatively coupled with the sensors 28 dispersed along the fluid couplings of the bleed air system 20. The memory 64 can include random access memory (RAM), read-only memory (ROM), flash memory, or one or more different types of portable electronic memory, such as discs, DVDs, CD-ROMs, etc., or any suitable combination of these types of memory. The controller module 60 or processor 62 can further be configured to run any suitable programs. Non-limiting embodiments of the disclosure can be included wherein, for example, the controller module 60 or processor 62 can also be connected with other controllers, processors, or systems of the aircraft 10, or can be included as part of or a subcomponent of another controller, processor, or system of the aircraft 10. In one example, the controller module 60 can include a full authority digital engine or electronics controller (FADEC), an onboard avionic computer or controller, or a module remoted located by way of a common data link or protocol.

A computer searchable database of information can be stored in the memory 64 and accessible by the controller module 60 or processor 62. The controller module 60 or processor 62 can run a set of executable instructions to display the database or access the database. Alternatively, the controller module 60 or processor 62 can be operably coupled to a database of information. For example, such a database can be stored on an alternative computer or controller. It will be understood that the database can be any suitable database, including a single database having multiple sets of data, multiple discrete databases linked together, or even a simple table of data. It is contemplated that the database can incorporate a number of databases or that the database can actually be a number of separate databases. The database can store data that can include, among other things, historical data related to the reference value for the sensor outputs, as well as historical bleed air system 20 data for the aircraft 10 and related to a fleet of aircraft. The database can also include reference values including historic values or aggregated values.

During gas turbine engine 12 operation, the bleed air system 20 supplies a low pressure bleed airflow 66 along the low pressure bleed port 34 and a high pressure bleed airflow 68 along the high pressure bleed port 36, as previously explained. The high pressure bleed airflow 68 is delivered to the turbine section 40 of the turbo air cycle machine 38, which in turn interacts with the turbine to drive the rotation of the turbine section 40. The high pressure bleed airflow 68 exits the turbine section 40 at the turbine output 56 as a turbine output airflow 70. A first portion of the low pressure bleed airflow 66 can be delivered to the compressor section 42 of the turbo air cycle machine 38, and a second portion of the low pressure bleed airflow 66 can be delivered to the turbine section 40 of the turbo air cycle machine 38, depending on the operation of the check valve 52 or upstream turbo-ejector or mixing-ejector proportional assembly, or the respective airflows 66, 68 of the respective low pressure bleed port 34 and high pressure bleed port 36, as explained herein. For example, embodiments of the disclosure can include operations wherein the airflow delivered to the turbine section 40 can include entirely low pressure bleed airflow 66, no low pressure bleed airflow 66, or a portion therebetween. The traversal of the second portion of the low pressure bleed airflow 66 can also be utilize to drive the rotation of the turbine section 40, such as when the controllable valve 50 is set to provide no high pressure bleed airflow 68.

The first portion of the low pressure bleed airflow 66 can be compressed by the rotation of the compressor section 42, which is rotatably coupled with the turbine section 40. The compressed low pressure bleed airflow 66 exits the compressor section 42 at the compressor output 54 as a compressor output airflow 72.

The compressor output flow 72 then travels through the heat exchanger 80 where it can be optionally cooled. For example, the compressor output flow 72 can be cooled based on a desired temperature demand from the ECS 48. If the sensors 28 indicate that the lower pressure airflow 70 and the compressor output flow 72 when combined will produce a combined airflow stream 74 that is too warm, then the fan air valve 92 can be operated by the controller module 60 to provide a flow of cooling air to the heat exchanger 80. If the sensors 28 indicate that the lower pressure airflow 70 and the compressor output flow 72 when combined will not produce a combined airflow stream 74 that is too warm, then the flow of cooling air will not be introduced to the heat exchanger 80 and the compressor output flow 72 will flow through the heat exchanger 80 without being cooled.

The turbine output airflow 70 and the compressor output airflow 72, which is optionally cooled, are combined in the turbo-ejector 44 to form a combined airflow stream 74, which is further provided to the ECS 48. In this sense, the combined airflow stream 74 can be expressed as a composition or a ratio of the low pressure and high pressure bleed airflow 66, 68, or a composition of a ratio of the turbine and compressor output airflows 70, 72.

The compression of the low pressure airflow 66, by the compressor section 42, generates a higher pressure and higher temperature compressor output airflow 72, compared with the low pressure airflow 66. Additionally, the airflows received by the turbine section 40, that is, the high pressure airflow 68 or the selective low pressure airflow 66 via the check valve 52 via a turbo-ejector or mixing-ejector proportional assembly, generates a lower pressure and a lower temperature turbine output airflow 70, compared with the turbine section 40 input airflows 66, 68. In this sense, the compressor section 42 outputs or emits a hotter and higher pressure airflow 72, while the turbine section 40 outputs or emits a cooler and lower pressure airflow 70, compared with the relative input airflows 66, 68.

The controller module 60 or processor 62 can be configured to operably receive a bleed air demand, generated by, for example, the ECS 48. The bleed air demand can be provided to the controller module 60 or processor 62 by way of a bleed air demand signal 76, which can include bleed air demand characteristics included, but not limited to, flow rate, temperature, pressure, or mass flow (e.g. airflow). In response to the bleed air demand signal 76, the controller module 60 or processor 62 can operably supply proportional amounts of the low pressure bleed airflow 66 and high pressure bleed airflow 68 to the turbo air cycle machine 38. The proportionality of the low pressure bleed airflow 66, and the high pressure bleed airflows 68 can be controlled by way of the respective first or second controllable valves 46, 50, and by selective operation of the check valve 52 or by way of the optional upstream turbo-ejector or mixing-ejector proportional assembly.

The proportional supplying of the low pressure and high pressure bleed airflows 66, 68 can be directly or geometrically proportional to the turbine output airflow 70 and compressor output airflow 72, or the turbine air cycle machine 38 operations. The turbine output airflow 70 and compressor output airflow 72 are combined downstream of the turbo air cycle machine 38, and the combined airflow stream 74 is provided to the ECS 48. In one non-limiting example, the compressor output airflow 72 can drive the turbine output airflow 70 into the narrow portion 58 and mix under sonic conditions. The mixed flow pressure will recover statically through the combined airflow stream 74 to output the turbo-ejector 44 at desired conditions. In this sense, the combined airflow stream 74 is conditioned by way of operation of the bleed air system 20, controllable valves 46, 50, check valve 52, turbo-ejector or mixing-ejector proportional assembly, turbo air cycle machine 38, the combining of the turbine output airflow 70 and the compressor output airflow 72, or any combination thereof, to meet the ECS 48 demand for bleed air.

One of the controller module 60 or processor 62 can include all or a portion of a computer program having an executable instruction set for determining the bleed air demand of the ECS 48, proportionally or selectively supplying the low pressure or high pressure bleed airflows 66, 68, operating the controllable valves 46, 50, the check valve's 52 or turbo-ejector or mixing-ejector proportional assembly's operation in response to the respective high pressure and low pressure airflows 66, 68, operating the fan air valve 92, or a combination thereof. As used herein, “proportionally or selectively supplying” the low pressure or high pressure bleed airflows 66, 68 can include altering or modifying at least one of the low pressure or high pressure bleed airflows 66, 68. For example, proportionally or selectively supplying the low pressure or high pressure bleed airflows 66, 68 can include altering the low pressure bleed airflow 66 without altering the high pressure bleed airflow 68, or vice versa. In another example proportionally or selectively supplying the low pressure or high pressure bleed airflows 66, 68 can include altering the low pressure bleed airflow 66 and the high pressure bleed airflow 68. Also as used herein, “proportionally” supplying the low pressure or high pressure bleed airflows 66, 68 can include altering or modifying the ratio of low pressure bleed airflow 66 to high pressure bleed airflow 68, based on the total bleed airflow 66, 68 supplied. Stated another way, the proportions of low or high pressure bleed airflow 66, 68 can be altered or modified, and a proportional ratio can be included or described based on the total airflow of the low and high pressure bleed airflows 66, 68.

Regardless of whether the controller module 60 or processor 62 controls the operation of the bleed air system 20, the program can include a computer program product that can include machine-readable media for carrying or having machine-executable instructions or data structures stored thereon. Such machine-readable media can be any available media, which can be accessed by a general purpose or special purpose computer or other machine with a processor. Generally, such a computer program can include routines, programs, objects, components, data structures, and the like, that have the technical effect of performing particular tasks or implementing particular abstract data types. Machine-executable instructions, associated data structures, and programs represent examples of program code for executing the exchange of information as disclosed herein. Machine-executable instructions can include, for example, instructions and data, which cause a general-purpose computer, special purpose computer, or special purpose processing machine to perform a certain function or group of functions.

While the bleed air characteristics of the low pressure or high pressure bleed airflows 66, 68 can remain relatively consistent or stable during a cruise portion of a flight by the aircraft 10, varying aircraft 10 or flight characteristics, such as altitude, speed or idle setting, heading, solar cycle, or geographic aircraft location can produce inconsistent airflows 66, 68 in the bleed air system 20. Thus, the controller module 60 or processor 62 can also be configured to operate the bleed air system 20, as explained herein, in response to receiving a set of sensor input values received by the sensors 28 dispersed along the fluid couplings of the bleed air system 20. For example, the controller module 60 or processor 62 can include predetermined, known, expected, estimated, or calculated values for the set of airflows 66, 68, 70, 72, 74 traversing the bleed air system 20. In response to varying aircraft 10 or flight characteristics, the controller module 60 or processor 62 can alter the proportional supplying of the low pressure or high pressure bleed airflows 66, 68 or the introduction of the cooling air via the fan air valve 92 in order to meet the bleed air demand for the ECS 48. Alternatively, the memory 64 can include a database or lookup table such that a proportional supplying values related to the low pressure or high pressure bleed airflows 66, 68 can be determined in response to the controller module 60 receiving a set or subset of sensor 28 readings, measurements, or the like.

In one non-limiting example the controller module 60 can control the high pressure controllable valve 50 to control an exit pressure of the combined airflow stream 74 of the turbo-ejector 44. This can be considered a master control in baseline system logic. The controller module 60 can control the low pressure controllable valve 46 to control a compressor power balance and such can be a slave control to that of the high pressure controllable valve 50. Stated another way, the low pressure controllable valve 46 can track, sense, measure, or respond to the high pressure controllable valve 50 to maintain an energy balance between the compressor section 42 and the turbine power rather than operating independently. The controller module 60 can control the fan air valve 92 to control an exit temperature of the combined airflow stream 74 of the turbo-ejector 44 and such control can be linked to master control of the high pressure controllable valve 50. Such baseline system logic would also include a closed position of the check valve 52.

Aspects of the above disclosure with the supplemental compressor exit heat exchanger allows for cooler compressor exit temperature and, in turn, increases turbo-ejector 44 efficiency. In one embodiment, the high pressure compressed air at the outlet 84 of the heat exchanger 80 can be lower in temperature than that of the low pressure expanded air at the turbine output 56, which can cause or affect an adiabatic change in efficiency of the turbo-ejector 44 as the two airflows are mixing. In other word, this phenomenon maximizes the efficiency of the turbo-ejector 44 as a pumping mechanism and as it recovers turbine section 40 exhaust energy through entrainment. The fan air valve 92 allows cool fan air to act as the heat sink, when needed, for the heat exchanger 80 and can exhaust to ambient.

While sensors 28 are described as “sensing,” “measuring,” or “reading” respective temperatures, flow rates, or pressures, the controller module 60 or processor 62 can be configured to sense, measure, estimate, calculate, determine, or monitor the sensor 28 outputs, such that the controller module 60 or processor 62 interprets a value representative or indicative of the respective temperature, flow rate, pressure, or combination thereof. Additionally, sensors 28 can be included proximate to, or integral with additional components not previously demonstrated. For example, embodiments of the disclosure can include sensors 28 located to sense the combined airflow stream 74, or can include sensors 28 located within the narrow portion 58, or “throat” of the turbo-ejector 44.

In another non-limiting example of responsive operation, the controller module 60 can operate the second controllable valve 50 based on a bleed air demand of the bleed air system 20. The bleed air demand can include, for example, a desired or demanded output airflow stream 74 from the turbo-ejector 44. In this sense, the controller module 60 can operate the second controllable valve 50 based on a desired or demanded output airflow stream 74 of the turbo-ejector 44. The controller module 60 can further operate, for example, the fan air valve 92 such that the heat exchanger 80 affects a cooling of the compressor output airflow 72, which in turn operably affects or controls the temperature of the output airflow stream 74, based on a bleed air demand of the bleed air system 20, such as a desired or demanded temperature of the output airflow stream 74. Thus, during operation, if the temperature of the output airflow stream 74 is below or less than a threshold, demanded, or desired temperature, as sensed by a sensor 28, the fan air valve 92 can be operably closed such that no cool air will flow to the heat exchanger 80. During operation, if the temperature of the output airflow stream 74 is above or greater than the threshold, demanded or desired temperature of the output airflow stream 74, as sensed by a sensor 28, the fan air valve 92 can be operably opened such that the heat exchanger 80 can operably lower the temperature of the compressor output airflow 72, and ultimately, the output airflow stream 74.

In another non-limiting example of responsive operation, the controller module 60 can operate the second controllable valve 50 based on a bleed air demand including a desired or demanded pressure of the output airflow stream 74. If the pressure of the output airflow stream 74, as sensed by a sensor 28, is below or less than a threshold, demanded, or desired pressure, the second controllable valve 50 can operably opened to provide or allow a portion or additional high pressure bleed airflow 68 to the turbo air cycle machine 38. As the second controllable valve 50 provides or allows high pressure bleed airflow 68 to the turbo air cycle machine 38, the turbine section 40 will rotate faster, generating more rotational power, which in turn, operates the compressor section 42 to compress more airflow. In this non-limiting responsive operation, the first controllable valve 46 can be controllably operated by the controller module 60, and based on the compressor output airflow 72, as sensed by the sensor 28, maintain a power balance between the turbine section 40 generating power and the compressor section 42 absorbing power. In this sense, the controller module 60 can be configured to operate the first and second controllable valves 46, 50 simultaneously.

The increase in rotating speed of the of the compressor section 42 will increase the pressure of the compressor output airflow 72. The increase in compression by the compressor section 42 also increases the temperature of the compressor output airflow 72, and thus, further controlling of the fan air valve 92 can operate to increase cooling via the heat exchanger 80 to maintain the temperature and pressure at the output airflow stream 74 of the turbo-ejector 44. The aforementioned configuration and operation of the valves 46, 50, 92 and the heat exchanger 80 allows for, causes, or affects the adiabatic change in efficiency of the turbo-ejector.

Embodiments of the disclosure can be included wherein the controller module 60 or processor 62 can be configured to operate the bleed air system 20 to account for sensor 28 measurements in the set or a subset of the airflows 66, 68, 70, 72, 74.

In another embodiment of the disclosure, the bleed air system 20 can operate without feedback inputs, that is, without the controller module 60 or processor 62 receiving sensed information from the sensors 28. In this alternative configuration, the controller module 60 or processor 62 can be configured to operate the first or second controllable valves 46, 50, the fan air valve 92, and the like based on a continuous operation of the aircraft 10, given the dynamic responses as observed during the aircraft 10 flight phases.

In one non-limiting example configuration of the bleed air system 20, wherein the ambient air outside of the aircraft 10 has an air pressure of 2.72 pounds per square inch, absolute (psiA) and a temperature of −24.70 degrees Fahrenheit (F), the low pressure bleed airflow can include a pressure of 25.73 psi, gage (psiG) and a temperature of 462.31 degrees F., while high pressure bleed airflow can include a pressure of 78.33 psiG and a temperature of 870.15 degrees. In this example, a ratio of low pressure bleed airflow 66 to high pressure bleed airflow 68 can be 51.61% to 48.39%. This ratio can operate the turbo air cycle machine 38 to produce a turbine output airflow 70 having a pressure of 32.14 psiG and a temperature of 641.26 degrees F., while the compressor output airflow 72 can include a pressure of 56.22 psiG and a temperature of 669.54 degrees F. The turbo-ejector 44 can be configured to combine the turbine output airflow 70 and the compressor output airflow 72 to provide a combined airflow stream 74 including a pressure of 41.96 psiG and a temperature of 655.85 degrees F. When the compressor output airflow 72 is optionally cooled, for example, by way of the heat exchanger 80, the temperature of the combined airflow stream 74 can be reduced to below 450 degrees F., by removing approximately 17.66 kiloWatts of thermal energy.

In another non-limiting example configuration of the bleed air system 20, wherein the ambient air outside of the aircraft 10 has an air pressure of 2.72 pounds per square inch, absolute (psiA) and a temperature of −24.70 degrees Fahrenheit (F), the low pressure bleed airflow can include a pressure of 21.43 psi, gage (psiG) and a temperature of 398.99 degrees F, while high pressure bleed airflow can include a pressure of 71.43 psiG and a temperature of 834.62 degrees. In this example, a ratio of low pressure bleed airflow 66 to high pressure bleed airflow 68 can be 51.71% to 48.29%. This ratio can operate the turbo air cycle machine 38 to produce a turbine output airflow 70 having a pressure of 28.41 psiG and a temperature of 608.49 degrees F., while the compressor output airflow 72 can include a pressure of 50.38 psiG and a temperature of 605.04 degrees F. The turbo-ejector 44 can be configured to combine the turbine output airflow 70 and the compressor output airflow 72 to provide a combined airflow stream 74 including a pressure of 37.44 psiG and a temperature of 606.71 degrees F. When the compressor output airflow 72 is optionally cooled, for example, by way of the heat exchanger 80, the temperature of the combined airflow stream 74 can be reduced to below 450 degrees F., by removing approximately 12.61 kiloWatts of thermal energy.

In another non-limiting example configuration of the bleed air system 20, wherein the ambient air outside of the aircraft 10 has an air pressure of 2.72 pounds per square inch, absolute (psiA) and a temperature of −24.70 degrees Fahrenheit (F), the low pressure bleed airflow can include a pressure of 15.49 psi, gage (psiG) and a temperature of 296.21 degrees F., while high pressure bleed airflow can include a pressure of 61.72 psiG and a temperature of 780.57 degrees. In this example, a ratio of low pressure bleed airflow 66 to high pressure bleed airflow 68 can be 52.03% to 47.96%. This ratio can operate the turbo air cycle machine 38 to produce a turbine output airflow 70 having a pressure of 23.18 psiG and a temperature of 558.30 degrees F., while the compressor output airflow 72 can include a pressure of 42.34 psiG and a temperature of 500.01 degrees F. The turbo-ejector 44 can be configured to combine the turbine output airflow 70 and the compressor output airflow 72 to provide a combined airflow stream 74 including a pressure of 31.19 psiG and a temperature of 527.99 degrees F. When the compressor output airflow 72 is optionally cooled, for example, by way of the heat exchanger 80, the temperature of the combined airflow stream 74 can be reduced to below 450 degrees F., by removing approximately 5.70 kiloWatts of thermal energy.

In yet another non-limiting example configuration of the bleed air system 20, wherein the ambient air outside of the aircraft 10 has an air pressure of 2.72 pounds per square inch, absolute (psiA) and a temperature of −24.70 degrees Fahrenheit (F), the low pressure bleed airflow can include a pressure of 9.99 psi, gage (psiG) and a temperature of 182.13 degrees F., while high pressure bleed airflow can include a pressure of 51.21 psiG and a temperature of 712.97 degrees. In this example, a ratio of low pressure bleed airflow 66 to high pressure bleed airflow 68 can be 51.62% to 48.37%. This ratio can operate the turbo air cycle machine 38 to produce a turbine output airflow 70 having a pressure of 17.52 psiG and a temperature of 495.16 degrees F., while the compressor output airflow 72 can include a pressure of 32.79 psiG and a temperature of 382.77 degrees F. The turbo-ejector 44 can be configured to combine the turbine output airflow 70 and the compressor output airflow 72 to provide a combined airflow stream 74 including a pressure of 23.95 psiG and a temperature of 437.13 degrees F. Since this temperature output is below 450 degrees F., no optional cooling by way of the heat exchanger 80 is needed. The aforementioned example configurations and values are merely non-limiting examples of the bleed air system 20 described herein.

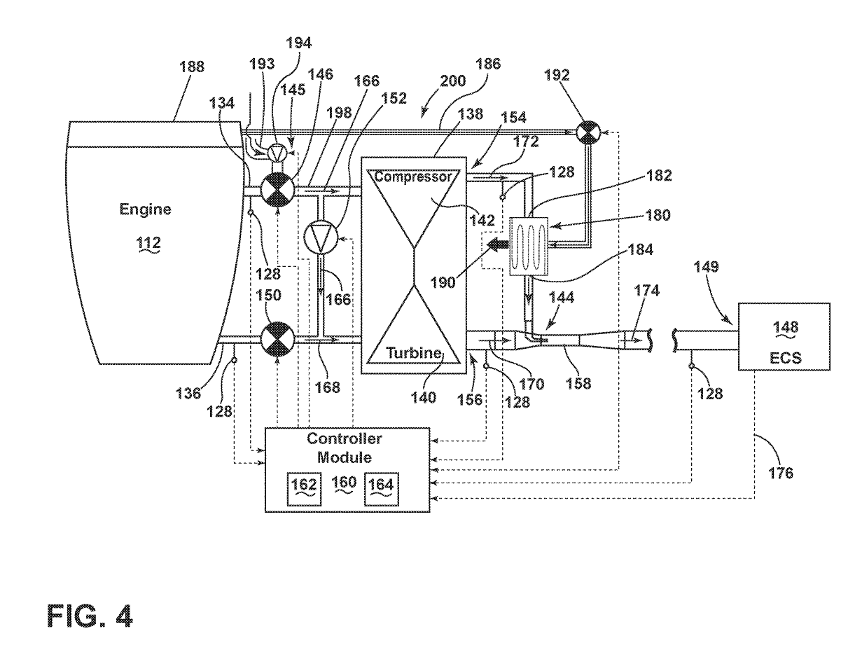

FIG. 4 illustrates an alternative portion of an aircraft 110 including a gas turbine engine 112, bleed air system 120, and ECS 148. The aircraft 110 is similar to the aircraft 10 previously described and therefore, like parts will be identified with like numerals increased by 100, with it being understood that the description of the like parts of the aircraft 10 applies to the parts of the aircraft 210, unless otherwise noted.

One difference is that an ambient air inlet 193 and alternative first controllable valve 146 have been included. More specifically, the ambient air inlet 193 is illustrated as being selectively fluidly coupled, by way of the first controllable valve 146 with the turbo air cycle machine 138 and check valve 152. In this manner the first controllable valve 146 acts as a source selection valve for supplying an ambient airflow or the low pressure bleed airflow 166. In this sense, the first controllable valve 146 can operate to supply only one or the other of the ambient airflow or the low pressure bleed airflow 166. As illustrated the first controllable valve 146 can include an integrated check valve 194. Embodiments of the disclosure can be included wherein the integrated check valve 194 is selected or configured to provide fluid traversal or selective fluid traversal from the ambient air inlet 193 toward the low pressure bleed airflow 166 or the conduit 198 that would otherwise house the low pressure bleed airflow 166, as provided by the first controllable valve 146. In another example, the integrated check valve 194 can be selected or configured such that the integrated check valve 194 closes, or self-actuates to a closed position under back pressure, that is when the pressure within the conduit 198 is higher or greater than the air pressure of the ambient air inlet 193. In another example, the integrated check valve 192 can be configured to selected to self-actuate relative to a predetermined air pressure sufficient to operate the turbo air cycle machine 138 In this sense, the integrated check valve 194 can prevent low bleed pressure air to backflow into the ambient air inlet 193. Additionally, the integrated check valve can be configured to provide all proportional supplying capabilities described herein.

It is contemplated that ambient air flow like the low pressure bleed airflow 166 can be provided to the turbine section 140 or the compressor section 142 of the turbo air cycle machine 138. Operation of the bleed air system 120 works similarly to that described above except that ambient airflow can be proportionally supplied via the ambient air inlet 193 or low pressure bleed airflow can be supplied via the low pressure bleed port 134, as selected by the controller module 160 or the first controllable valve 146. Embodiments of the disclosure can include, but are not limited to, supplying up to 100% the low pressure bleed airflow 166 as ambient air and 0% of the low pressure bleed airflow 166. Another example embodiment of the disclosure can include, but is not limited to, proportionally supplying the ambient air, low pressure and high pressure bleed airflows. It is contemplated that a selection in the source by the first controllable valve 146 can be selected by the controller module 60 based on mission schedule.

The controller module 160 or processor 162 can be configured to operably receive a bleed air demand, generated by, for example, the ECS 148. The bleed air demand can be provided to the controller module 160 or processor 162 by way of a bleed air demand signal 176, which can include bleed air demand characteristics included, but not limited to, flow rate, temperature, or pressure. In response to the bleed air demand signal 176, the controller module 160 or processor 162 can operably supply proportional amounts of ambient airflow, the low pressure bleed airflow 166 and the high pressure bleed airflow 168 to the turbo air cycle machine 138. The proportionality of the ambient airflow, the low pressure bleed airflow 166, and the high pressure bleed airflows 168 can be controlled by way of the respective first or second controllable valves 146, 150, and by selective operation of the check valve 152 or upstream turbo-ejector or mixing-ejector proportional assembly.

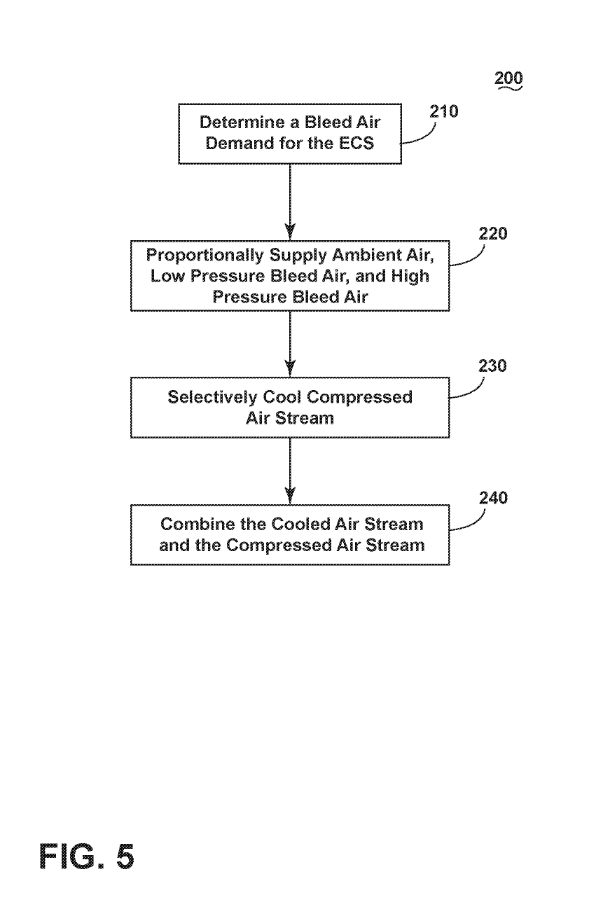

FIG. 5 illustrates a flow chart demonstrating a non-limiting example method 200 of providing bleed air to the ECS 48, 148 of an aircraft 10, 110 using a gas turbine engine 12, 112. The method 200 begins at 210 by determining a bleed air demand for the ECS 48, 148. The determining the bleed air demand at 210 can include determining at least one of an air pressure, an air temperature, or a flow rate demand for the ECS 48, 148, or a combination thereof. The bleed air demand can be a function of at least one of the number of aircraft 10 passengers, aircraft 10 flight phase, or operational subsystems of the ECS 48, 148. The bleed air demand can be determined by the ECS 48, 148 the controller module 60, 160 or the processor 62, 162 based on the bleed air demand signal 76, 176.

Next, at 220, the controller module 60, 160 or the processor 62, 162 operably controls the controllable valve assembly 45, 145 to proportionally supply the ambient, low pressure bleed air, and high pressure bleed air such that turbo air cycle machine 38, 138 emits a cooled air stream from the turbine section 40, 140 and a compressed air stream from the compressor section 42, 142. As used herein, a “cooled” airstream can describe an airflow having a lower temperature than the airflow received by the first turbine section 40. Non-limiting embodiments of the disclosure can include supplying up to 100% of the combined airflow stream 74, 174 from one of the ambient air, low pressure bleed air or high pressure bleed air and 0% of the corresponding of the ambient air, low pressure bleed air or high pressure bleed air. Another example embodiment of the disclosure can include, but is not limited to, proportionally supplying the ambient air, low pressure bleed air and high pressure bleed air, wherein the supplying is related to, or is a function of the aircraft 10, 110 flight phase or rotational speed of the gas turbine engine 12, 112. The proportionally supplying of the ambient air and bleed air at 220 can include continuously or repeatedly altering the proportional supplying of the ambient, low pressure bleed air and high pressure bleed air over a period of time, or indefinitely during the flight of the aircraft 10, 110.

At 230, the compressed air stream can be optionally cooled. The controller module 60, 160 or the processor 62, 162 operably controls the fan air valve 92, 192 to provide cooling air to the heat exchanger 80, 180. At 240, the method 200 continues by combining the cooled air stream and the compressed air stream, optionally cooled or not, to form a conditioned or combined airflow stream 74, 174.

It will be understood that the proportional supplying the low pressure and the high pressure bleed air at 220 and the selective cooling at 230 is controlled by the controller module 60, 160 or processor 62, 162 such that the combined airflow stream 74, 174 meets or satisfies the determined bleed air demand for the ECS 48, 148. The sequence depicted is for illustrative purposes only and is not meant to limit the method 200 in any way as it is understood that the portions of the method can proceed in a different logical order, additional or intervening portions can be included, or described portions of the method can be divided into multiple portions, or described portions of the method can be omitted without detracting from the described method.

Many other possible embodiments and configurations in addition to that shown in the above figures are contemplated by the present disclosure. For example, embodiments of the disclosure can be included wherein the second controllable valve 50, 150 could be replaced with a bleed ejector or mixing valve also coupled with the low pressure bleed port 34, 134. In another non-limiting example, the turbo-ejector 44, 144 the compressor output 54, 154, or the turbine output 56, 156 can be configured to prevent backflow from downstream components from entering the turbo air cycle machine 38, 138. In yet another non-limiting example, the ambient air supplied via the fan air valve 92, 192 can be further supplied from the low pressure bleed port 34, 134.

In yet another non-limiting example embodiment of the disclosure, the check valve 52, 152 or turbo-ejector proportional assembly can include, or can be replaced by a third controllable valve, and controlled by the controller module 60, 160 as explained herein, to operate or effect a ratio of low pressure bleed airflow 66, 166 and high pressure bleed airflow 68, 168 supplied to the turbine section 40, 140. Additionally, the design and placement of the various components such as valves, pumps, or conduits can be rearranged such that a number of different in-line configurations could be realized.

The embodiments disclosed herein provide a method and aircraft for providing bleed air to an environmental control system. The technical effect is that the above described embodiments enable the preconditioning of bleed air received from a gas turbine engine such that the conditioning and combining of the bleed air is selected to meet a bleed air demand for the environmental control system.

One advantage that can be realized in the above embodiments is that the above described embodiments have superior bleed air conditioning for the ECS without wasting excess heat, compared with traditional pre-cooler heat exchanger systems. Another advantage that can be realized is that by eliminating the waste of excess heat, the system can further reduce bleed extraction from the engine related to the wasted heat. By reducing bleed extraction, the engine operates with improved efficiency, yielding fuel cost savings and increasing operable flight range for the aircraft.

Yet another advantage that can be realized by the above embodiments is that the bleed air system can provide variable bleed air conditioning for the ECS. The variable bleed air can meet a variable demand for bleed air in the ECS due to a variable ECS load, for example, as subsystems are operated or cease to operate. This includes the advantage of the ability to transform low stage bleed air to air that is suitable for the ECS. Low pressure bleed air pressure and ambient air pressure can be augmented to a desired pressure for the ECS.

Yet another advantage includes that waste cooling energy can be utilized to further assist cooling temperatures of the air for use in the ECS.

To the extent not already described, the different features and structures of the various embodiments can be used in combination with each other as desired. That one feature cannot be illustrated in all of the embodiments is not meant to be construed that it cannot be, but is done for brevity of description. Thus, the various features of the different embodiments can be mixed and matched as desired to form new embodiments, whether or not the new embodiments are expressly described. Moreover, while “a set of” various elements have been described, it will be understood that “a set” can include any number of the respective elements, including only one element. Combinations or permutations of features described herein are covered by this disclosure.

This written description uses examples to disclose embodiments of the invention, including the best mode, and also to enable any person skilled in the art to practice embodiments of the invention, including making and using any devices or systems and performing any incorporated methods. The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of providing bleed air to environmental control systems using a gas turbine engine, the method comprising:
determining a bleed air demand for the environmental control systems;
selectively supplying low pressure bleed air and high pressure bleed air from a compressor of the gas turbine engine to a turbine section and compressor section of a turbo air cycle machine, with the turbine section emitting a cooled air stream and the compressor section emitting a compressed air stream;
selectively cooling the compressed air stream; and
combining the cooled air stream emitted from the turbine section and the compressed air stream emitted from the compressor section to form a conditioned air stream;
wherein the selectively supplying and selectively cooling are controlled such that the conditioned air stream satisfies the determined bleed air demand.

2. The method of claim 1 wherein selectively cooling the compressed air stream comprises providing the compressed air stream to a heat exchanger and selectively providing cooler fan air to the heat exchanger as a heat sink for the compressed air stream.

3. The method of claim 1 wherein selectively supplying low pressure bleed air further comprises selectively supplying low pressure bleed air or ambient air to the compressor section.

4. The method of claim 3 wherein selectively supplying low pressure bleed air and ambient air comprises supplying 100% of one of the low pressure bleed air or ambient air and 0% of the other of the low pressure bleed air or ambient air.

5. The method of claim 1 wherein the determining the bleed air demand comprises determining at least one of air pressure or air temperature demand for the environmental control systems.

6. The method of claim 5 wherein the determining the bleed air demand comprises determining both the air pressure and the air temperature demand for the environmental control systems.

7. The method of claim 1 wherein the bleed air demand is a function of at least one of number of aircraft passengers, aircraft flight phase, or operational subsystems of the environmental control systems.

8. The method of claim 1 wherein selectively supplying low pressure and high pressure bleed air comprises supplying 100% of one of the low pressure bleed air or the high pressure bleed air and 0% of the other of the low pressure bleed air or the high pressure bleed air.

9. The method of claim 1 wherein selectively supplying low pressure and high pressure bleed air comprises proportionally supplying the low pressure bleed air and the high pressure bleed air.

10. The method of claim 9 wherein the selectively supplying the low pressure bleed air and the high pressure bleed air is a function of an aircraft flight phase.

11. The method of claim 1 wherein selectively supplying low pressure and high pressure bleed air comprises continuously selectively supplying the low pressure bleed air and the high pressure bleed air.

12. An aircraft comprising:
an environmental control system having a bleed air inlet;
a gas turbine engine having a low pressure bleed air supply and a high pressure bleed air supply;
a turbo air cycle machine having rotationally coupled turbine section and compressor section;
an upstream turbo-ejector fluidly coupling the low pressure bleed air supply and the high pressure bleed air supply to the turbine section and compressor section;
a downstream turbo-ejector fluidly combining fluid outputs from the turbine section and compressor section into a common flow that is supplied to the bleed air inlet of the environmental control system; and
a heat exchanger having a hot side fluidly coupled between the compressor section and the downstream turbo-ejector.

13. The aircraft of claim 12 wherein the heat exchanger comprises a cool side selectively fluidly coupled to a cool fan air supply of the gas turbine engine.

14. The aircraft of claim 13, further comprising a fan air valve fluidly coupled between the cool fan air supply and the heat exchanger.

15. The aircraft of claim 12, further comprising a source valve fluidly coupling an ambient air supply to the low pressure bleed air supply in the upstream turbo-ejector.

16. The aircraft of claim 15 wherein the upstream turbo-ejector is configured to simultaneously supply the low pressure bleed air supply to the turbine section.

17. The aircraft of claim 16, further comprising a controller module configured to controllably operate at least one of the upstream turbo-ejector, downstream turbo-ejector, heat exchanger, fan air valve, or source valve.

18. A method of providing air to an environmental control systems of an aircraft, the method comprising:
selectively supplying ambient air and low pressure bleed air and high pressure bleed air from a compressor of a gas turbine engine to a turbo air cycle machine to precondition the ambient air and bleed air according to operational demands of the environmental control systems.

19. The method of claim 18 wherein preconditioning comprises compressing one of ambient air or low pressure bleed air to form a compressed air stream.

20. The method of claim 19 wherein preconditioning comprises selectively cooling the compressed air stream.
